(19) United States
(12) Patent Application Publication
(10) Pub. No.: US 2014/0317978 A1
(43) Pub. Date: Oct. 30, 2014

(54) Electric Wiring Device Marking System

(71) Applicant: Kyung Tae Kim, Laguna Niguel, CA (US)

(72) Inventor: Kyung Tae Kim, Laguna Niguel, CA (US)

(21) Appl. No.: 14/146,024

(22) Filed: Jan. 2, 2014

Related U.S. Application Data
(60) Provisional application No. 61/817,305, filed on Apr. 29, 2013.

(51) Int. Cl. G09F 3/06; G09F 3/00; G09B 21/00; G09F 3/10

(52) U.S. Cl. CPC G09F 3/06; G09F 3/10; G09F 3/00; G09B 21/003
USPC 40/638; 40/299.01; 40/663; 434/113

(57) ABSTRACT

An Electric Wiring Device Marking System which allows attachment of labeled (or non labeled) inserts or stickers in the proper orientation. In some embodiments, a system which utilizes a Post-Installation-Visible Date Stamp. In some embodiments, utilizing labeling which communicate by visual and/or tactile means.

### CROSS REFERENCE

This application claims priority to U.S. Provisional 61817305 (29 Apr. 2013).

### BACKGROUND

There exists a requirement to mark certain electric wiring devices to denote their function/operation. Although devices can be permanently marked from the factory, the devices can be installed in multiple rotational orientations in the field. This causes confusion for users when the permanent markings are not oriented properly due to differing installation orientations.

Stickers are currently used in some instances (e.g.—Ground Fault Circuit Interrupt (GFCI) protected receptacles), but are of limited value since they can be easily damaged and fall off.

### SUMMARY

One objective of the present invention is to provide a permanent marking system which can be quickly installed/applied in the proper orientation in a visually appealing and repeatable (i.e.—independent of installers' abilities) manner.

Another objective is to provide a marking system which can be quickly and cleanly removed (using appropriate tools).

Another objective is to provide a tactile communication means for visually impaired or blind users.

Another objective is to provide post-installation visible manufacturing date information for quality control/lifespan/tracking purposes.

In the preferred embodiment, an Electric Wiring Device Marking System (EWDMS) 1 simply consists of at least one Rotationally Independent Shaped Cavity (RISC) 2 into which at least one Locking Marking Insert (LMI) 5 can be installed/applied.

The RISC 2 is negatively trapezoidal in shape (i.e.—area of opening on the surface of the wiring device is smaller than the area of the base or bottom). The LMI 5 (labeled or blank) could be manufactured with at least two opposite edges shaped with a draft (angled) to lock it into the RISC 2. The LMI 5 can be made from any suitable (stiff yet flexible) material (e.g.—plastic, sheet metal, fiberglass, etc.) as well as in any color.

The EWDMS 1 could also incorporate post-installation visible manufacturing date information.

### DESCRIPTION OF THE DRAWINGS

Specific embodiments and modifications thereof will become apparent to those skilled in the art from the detailed description herein having reference to the figures that follow, of which:

FIG. 1 is a front view of an embodiment of an EWDMS 1 of the present invention incorporated into a duplex (dual socket) receptacle.

FIG. 1A is a detailed view of Section A of FIG. 1.

FIG. 2 is a top isometric view of FIG. 1.

FIG. 2B is a detailed view of Section B of FIG. 2.

FIG. 3 is a top isometric view of a labeled embodiment of FIG. 1.

FIG. 3C is a detailed view of Section C of FIG. 3.

FIG. 4 is a top isometric view of a horizontal EWDMS 1 duplex receptacle of FIG. 1.

FIG. 5 is a front view of a Tactilely Communicative LMI (TCLMI) 10.

FIG. 6 is a top isometric view of FIG. 5.

FIG. 7 is a front view of the EWDMS duplex receptacle of FIG. 1 with a TCLMI 10 of FIG. 5 installed.

### DETAILED DESCRIPTION

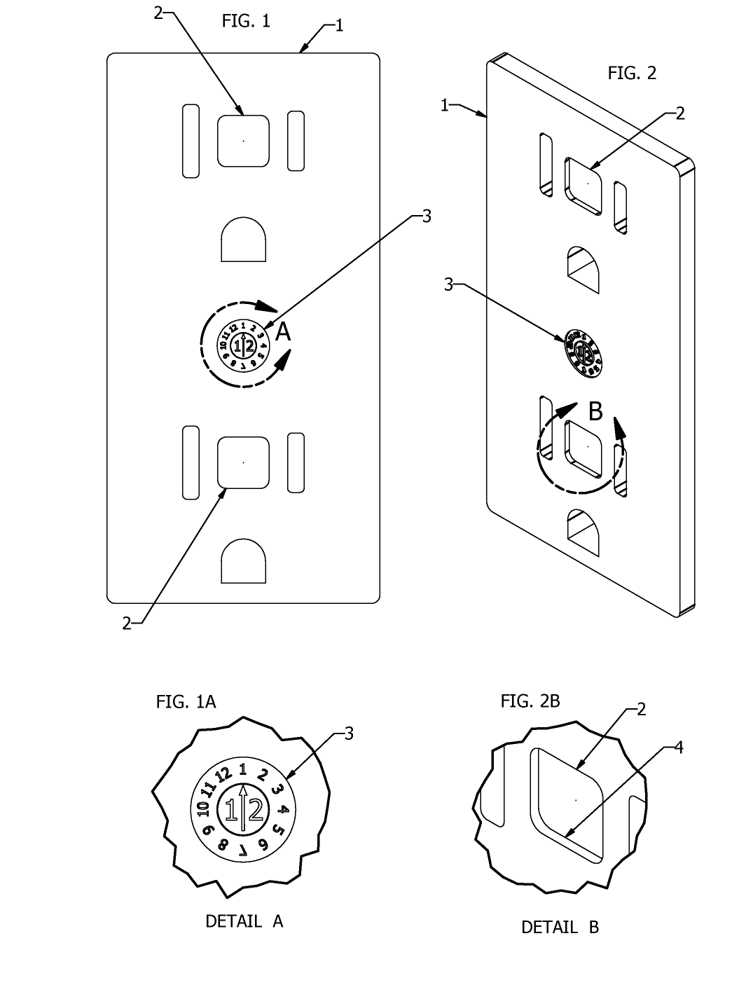

FIG. 1 is a front view of a duplex receptacle embodiment of an EWDMS 1 of the present invention with RISCs 2 and Post-Installation-Visible Manufacturing Date Stamp (PIVMDS) 3. FIG. 1A is a detailed view of Section A of FIG. 1 showing this device's manufacturing date as January of 2012. The PIVMDS 3 facilitates quality control/device life span/tracking issues without removal/uninstallation of the device (as it is currently required) should any arise.

FIG. 2 is a top isometric view of FIG. 1. FIG. 2B is a detailed view of Section B of FIG. 2 showing the Negatively Angled Locking Surfaces (NALS) 4 of the RISC 2.

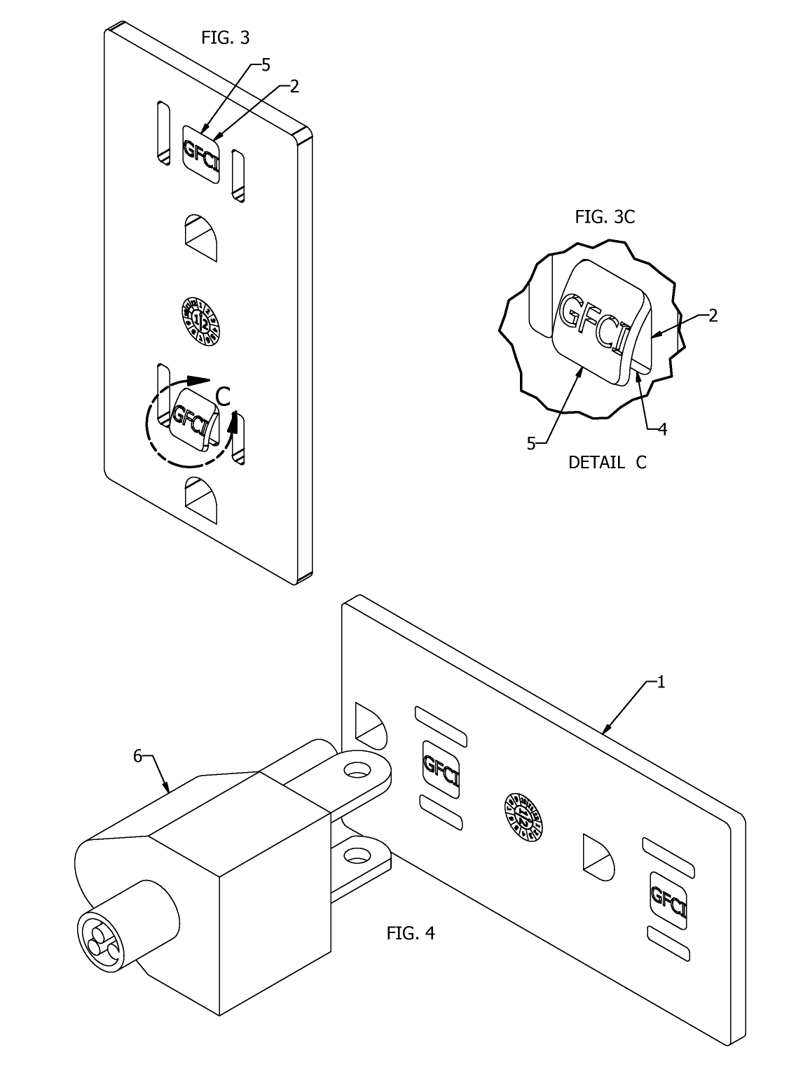

FIG. 3 is a top isometric view of a labeled embodiment of FIG. 1 with GFCI labeled LMIs 5. FIG. 3C is a detailed view of Section C of FIG. 3 showing the installation method of bending the LMI 5 to “snap-in” the LMI 5 into the NALS 4 of RISC 2. An additional advantage of snap-in type inserts is that they can be cleanly removed using appropriate tools (e.g.—sharped edged knife) as opposed to leaving adhesive residue when stickers are used.

FIG. 4 is a top isometric view of a horizontally installed EWDMS 1 duplex receptacle of FIG. 1 with properly oriented GFCI LMIs and a grounded plug 6 about to be plugged in.

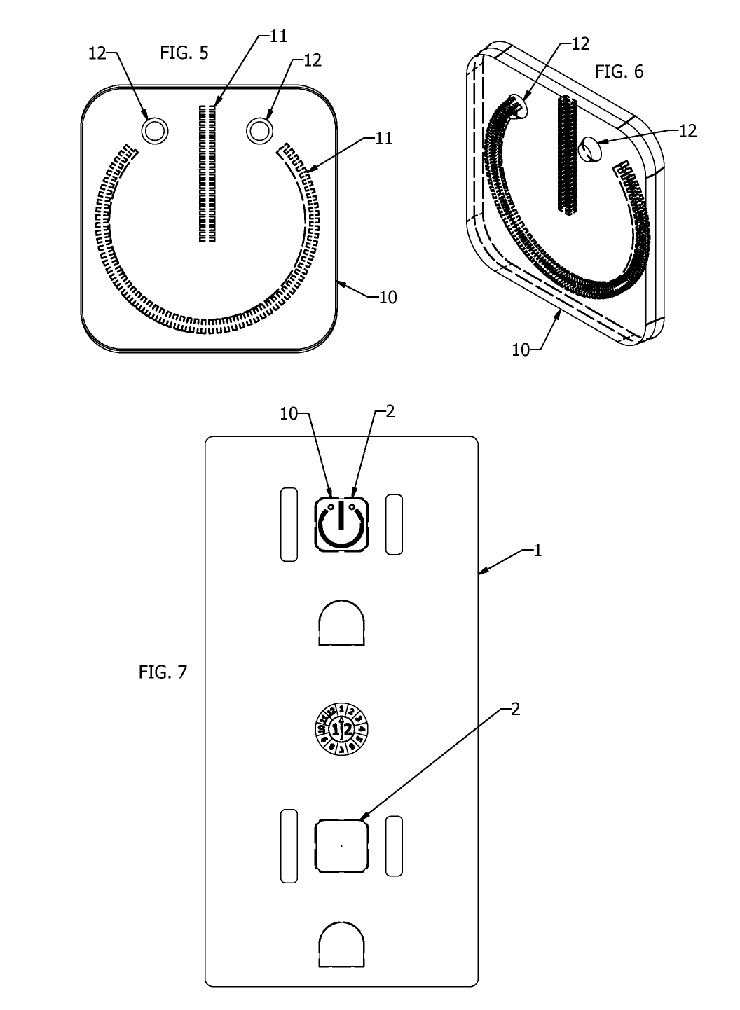

FIG. 5 is a front view of a TCLMI 10 incorporating tactile protruding bumps 12 and an ON/OFF Control Symbol 11. FIG. 6 is a top isometric view of FIG. 5.

FIG. 7 is a front view of the EWDMS duplex receptacle of FIG. 1 with a TCLMI 10 of FIG. 5 installed in the upper RISC 2 (tactilely and visually communicating that the upper socket is switch controlled) and no LMI in the bottom RISC 2 (the lack of a LMI signifying a continually “Hot” or normal socket).

Although certain embodiments, features, and examples have been described herein, it will be understood that aspects described in the present disclosure may be differently combined and/or modified to form further embodiments.

For example, the present invention can be utilized with any wiring device (regardless of voltage or Ampere rating) worldwide (e.g.—NEMA 5-15, 5-20, Type A through M (as well as any other) receptacles, switches, occupancy sensors, timers, etc.).

RISC 2 could be any other (90 degree) rotationally independent shape (e.g.—circle, hexagon, octagon, etc.) and be in alternate locations (e.g.—on either side of the ground hole, center of device, etc.).

The LMIs could also be manufactured from thick sheets of clear plastic (similar to plastic clamshell packaging) since the NALS 4 of the RISC 2 will lock the plastic sheet LMI in place. The plastic sheet LMI could incorporate printing and/or adhesive faced printed markings (i.e.—adhesive on the same side as the printed marking) which could be applied to the backside of the clear plastic sheet. The plastic sheet LMI would thus protect its underside adhesive marking after installation.

Other suitable locking means such as divots, notches, or indexes could be utilized instead of the NALS.

Marking Inserts could also utilize alternate suitable methods (e.g.—adhesives, stickers, velcro, magnets, etc.) with or without “Locking” features. The cavity of the RISC could offer protection (of the Marking Inserts) and thus significantly increase the durability/permanence of the Marking Inserts when utilizing these methods.

Alternate embodiments of RISCs could be formed by a raised perimeter (from the surface of the electric device) around the Marking Inserts instead of being sunken from the surface.

Only electric devices have been described, but it should be understood that the invention could apply to the electric devices' accessories as well (e.g.—wall plates/covers, boxes, etc.).

Finally, although only two embodiments of LMIs were shown, any number, symbol, word, protrusion(s), divot(s), color, or any combination(s) thereof (visual and/or tactile) could be utilized (e.g.—AFCI, Tamper Resistant, WX TR, etc.).

Alternative embodiments and/or uses of the methods and devices described above and modifications and equivalents thereof are intended to be included within the scope of the present invention. Thus it is intended that the scope of the present invention be determined only by a fair reading of the following claims.

1) An Electric Wiring Device Marking System (EWDMS) comprising:
at least one electric wiring device and/or electric wiring device accessory further comprising at least one Marking/Labeling Means and at least one Cavity;
the Marking/Labeling Means configured to utilize Visual and/or Tactile Communication Means, and further configured to interface with the Cavity;
the Cavity comprising a shape that is not altered by installation orientation and further configured to protect the interfacing Marking/Labeling Means.

2) The EWDMS of claim 1 where at least a Snap-In type interface is utilized.

3) The EWDMS of claim 1 where at least a Stick-On/Adhesive type interface is utilized.

4) The EWDMS of claim 1 where the Tactile Communication Means is Braille.

5) An Electric Wiring Device Marking System (EWDMS) comprising:
at least one electric wiring device and/or electric wiring device accessory further comprising at least one Marking/Labeling Means, at least one Cavity, and at least one Post-Installation-Visible Manufacturing Date Indication Means;
the Marking/Labeling Means configured to utilize Visual and/or Tactile Communication Means, and further configured to interface with the Cavity;
the Cavity comprising a shape that is not altered by installation orientation and further configured to protect the interfacing Marking/Labeling Means.

6) EWDMS of claim 5 where at least a Snap-In type interface is utilized.

7) EWDMS of claim 5 where at least a Stick-On/Adhesive type interface is utilized.

8) EWDMS of claim 5 where the Tactile Communication Means is Braille.

9) An EWDMS comprising at least one Post-Installation-Visible Manufacturing Date Indication Means.
